(19) United States
(12) Patent Application Publication
(10) Pub. No.: US 2025/0094026 A1
(43) Pub. Date: Mar. 20, 2025

(54) INTERACTIVE, APPLICATION ADJUSTABLE, REENTRANT DESIGN FOR USER GESTURE RECORDING

(71) Applicant: Oracle International Corporation, Redwood Shores, CA (US)

(72) Inventors: Horst Heistermann, Sunnyvale, CA (US); Nathan Angstadt, Colorado Springs, CO (US); Arif Rafique, Parker, CO (US); Rajan Mahendrakumar Modi, Highlands Ranch, CO (US)

(21) Appl. No.: 18/816,906

(22) Filed: Aug. 27, 2024

Related U.S. Application Data
(60) Provisional application No. 63/538,829, filed on Sep. 17, 2023.

(51) Int. Cl. G06F 3/0484; G06F 3/01; G06F 16/957

(52) U.S. Cl. CPC G06F 3/0484; G06F 3/017; G06F 16/957

(57) ABSTRACT

Techniques for user gesture recording are provided. In one technique, while recording user actions with respect to a website, it is detected that a user entered text within a text field of a webpage of the website. An action pane is presented that includes a value text field and a test value text field. In response to the detection, the text is inserted into the test value text field of the action pane. An association between the text, the text field, and the test value text field is stored as part of a workflow. In a related technique, user input is received through the action pane, where the user input selects a reference, to a source of input, to include in the text field during execution of the workflow.

### BENEFIT CLAIM

This application claims under 35 U.S.C. § 119 (e) of provisional application 63/538,829, filed Sep. 17, 2023, by Horst Heistermann et al., the entire contents of which is hereby incorporated by reference.

### TECHNICAL FIELD

The present disclosure relates to online recorders that record user interactions with online data.

### BACKGROUND

RPA (or robotic process automation) is an integration technology that is used in place of calling APIs to be able to perform actions, such as create an order or get purchase order data from a database. Oftentimes an application might not have those APIs. Even if an application has an API, it may be tedious to write code that calls those APIs. Also, writing code that includes calls to APIs requires certain knowledge and skill that many users might not have. RPA allows (relatively unskilled) users to connect to systems with such applications. RPA interacts with an (e.g., online) application exactly the same way that a typical user would, such as opening up a web browser, logging in, navigating to certain webpages via links, and entering data into certain fields.

One way to enable RPA is through user gesture recording (such as recording user interactions with a webpage), which typically involves running a piece of software, such as a 3rd party library or browser plugin, and having it generate a script that records all the user gestures/interactions. Through user gesture recording, all the details that a user would end up ultimately doing to perform an online task are recorded and the recording is the way to teach a “robot” (or software) how to perform that task.

The output of the generated script is then manually analyzed and/or modified to create a data model that represents the recorded gestures in the application that is using the recording software. The analysis and modification of the generated script can be complex and, because it is often done manually, it becomes a tedious job for the user.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

In the drawings:

FIG. 1 is a block diagram that depicts an example recording system for recording user gestures with respect to a software application, in an embodiment;

FIGS. 2A-2H and 2J-2T are screenshots that depict a gesture recording process, in an embodiment;

FIG. 3 is a block diagram that illustrates a computer system upon which an embodiment of the invention may be implemented;

FIG. 4 is a block diagram of a basic software system that may be employed for controlling the operation of the computer system.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### General Overview

A system and method are provided for providing an interactive user gesture recording technique that allows a user to edit a recorder's output during the recording process. Instead of generating a script of recorded user actions and then manually modifying that script, a recorder generates events (reflecting user actions) to which an application program can subscribe during the recording process. A recorder event bus allows the application program to hook into the recorder. A user interface is added to the recorder that allows the user to view and edit a recorded action before an event reflecting that action is transmitted to the application program that receives events from the recorder. The application program may present the events in the form of a workflow, where each node in the workflow corresponds to a recorded user action.

### System Overview

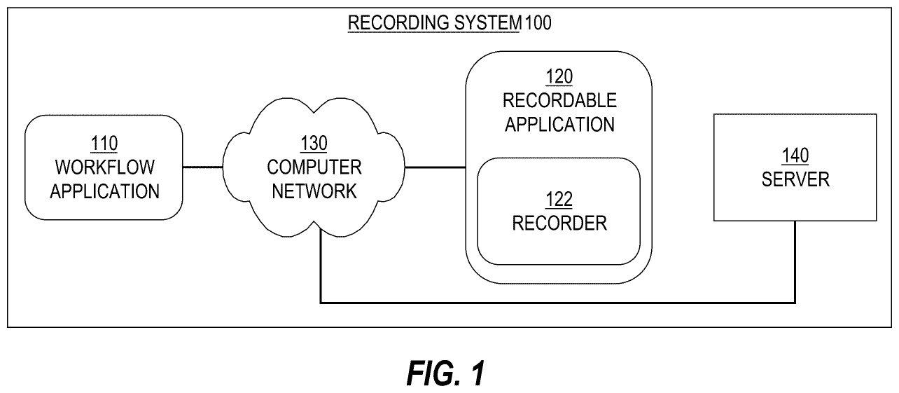

FIG. 1 is a block diagram that depicts an example recording system 100 for recording user actions with respect to a software application, in an embodiment. Recording system 100 includes a workflow application 110, a recordable application 120, a recorder 122, a computer network 130, and a server 140. Computer network 130 may comprise one or more local area networks (LANs), one or more wide area networks (WANs), and/or the Internet. As indicated in FIG. 1, workflow application 110 and server 140 communicate with each other over computer network 130 and recorder 122 and server 140 also communicate with each other over computer network 130. Alternatively, server 140 may communicate (a) with recorder 122 over a first computer network and (b) with workflow application 110 over a second computer network that is different than the first computer network. Each of applications 110, 120, recorder 122, and server 140 may be implemented in software, hardware, or any combination of software and hardware.

Recordable application 120 may execute within a web browser that is installed on a computing device, such as a laptop computer, a desktop computer, a tablet computer, or a smartphone. In fact, applications 110 and 120 may execute on the same computing device or different computing devices. If recordable application 120 executes within a web browser, then recorder 122 may be implemented as a plug-in or extension within the web browser.

A user provides input to recordable application 120. Input may comprise the user selecting (e.g., “clicking” using a cursor control device) one or more user interface (UI) elements, such as buttons, checkboxes, etc. Input may also comprise entering text in a text field, copying a text value or string, copying a cell that includes one or more text values or strings, or copying a table that includes multiple cells (each of which includes one or more text values or strings).

### Recorder

Recorder 122 detects each user input provided to recordable application 120 and automatically generates a record that indicates one or more aspects of the user input, such as with which UI element (if any) was interacted, where that UI element is located in a web page that recordable application 120 displays, what text (if any) was entered, and what text (if any) was selected. The location of a UI element (e.g., a button or text field) may be specified using a path name, such as an xpath, that uniquely identifies where the UI is in HTML code relative to other elements in the HTML code. Each record may also include a timestamp indicating when the user input was received, such as a date and/or time. Each record may also include a unique record identifier that uniquely identifies the record relative to other records that are generated during a recording session.

In an embodiment, recorder 122 transmits generated records to server 140 (e.g., over computer network 130). Server 140 stores records and may forward those records automatically to workflow application 110 (i.e., without input, such as an explicit request, from workflow application 110) (such as a “push” scenario) or based on input from workflow application 110 (such as a “pull” scenario). In the latter case, workflow application 110 may regularly ping server 140 (e.g., every two seconds) to request any records that recorder 122 has not yet sent to workflow application 110. Server 140 keeps track of which records from recordable application 120 have been forwarded to workflow application 110.

In an embodiment, recorder 122 is a browser extension. Also, recorder 122 may be written in JavaScript and may be installed by installing the extension in a web browser, examples of which include Chrome, Firefox, Edge, and Safari. In this embodiment, recorder 122 might not communicate with server 140 or an equivalent. Instead, recorder 122 may communicate with workflow application 110 using the web browser's messaging system. Thus, server 140 might not exist in another embodiment of recording system 100.

### Workflow

Workflow application 110 receives records generated by recordable application 120 and updates a user interface based on those records. The user interface includes a workflow that reflects a recording (created by recorder 122) of user interactions with recordable application 120. A workflow comprises a set of nodes that are connected, where each node corresponds to a user action and each node is connected to another node. A node may be visually represented by a two-dimensional shape (e.g., a circle, square, or rectangle) while a connection may be visually represented by a line that touches two nodes. Each connection connects a source node to a target node. A connection reflects a transition (or change) from one state of recordable application 120 to another state of recordable application 120 based on the user action corresponding to the source node of the connection. For each record received from server 140 (where each record corresponds to an instance of user input relative to recordable application 120), workflow application 110 updates a workflow that is displayed in the user interface provided by workflow application 110, such as by including a new node to the workflow, where the new node correspond to the user action indicated in the record.

The user interface of workflow application 110 includes controls that allow a user (interfacing with workflow application 110) to modify the workflow, i.e., without records generated from recorder 122. Thus, a workflow may be created solely through user inputs to recordable application 120, solely through user inputs to workflow application 110, or a combination of the two sets of user inputs.

In an embodiment, after a user's actions with respect to recordable application 120 have begun to be recorded and before the user is done interacting with recordable application 120, a workflow is presented to the user (through workflow application 110), allowing the user to see what has been recorded thus far in the recording process. In the depicted embodiments in the figures, the workflow is presented in the left browser window (hereinafter “workflow window”) and the website being recorded is presented in the right browser window (hereinafter “recorded window”). For example, when a user selects a GUI element (e.g., a button) in the recorded window or types text into a text field in the recorded window, that action is recorded and a node or GUI element (corresponding to that action) in the workflow window is created and added to a workflow. The two windows may be presented in two different browsers, such as web browsers.

In an embodiment, a user initiates a recording of the user's actions with respect to recordable application 120, pauses the recording, makes changes to a workflow that is generated based on the recording thus far, and then resumes the recording. “Pausing a recording” may involve selecting a button in a user interface provided by recorder 122. Additionally or alternatively, “pausing a recording” may simply be the lack of user input with respect to recordable application 120 for a period of time. While a recording is paused, the user may provide input to recordable application 120 without that input being recorded by recorder 122.

### Recording Example

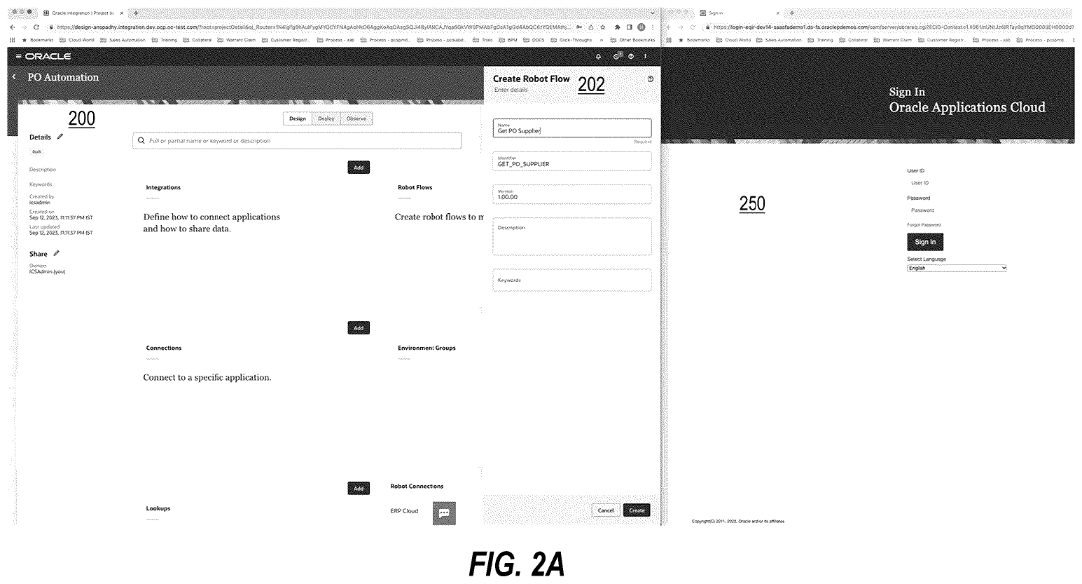

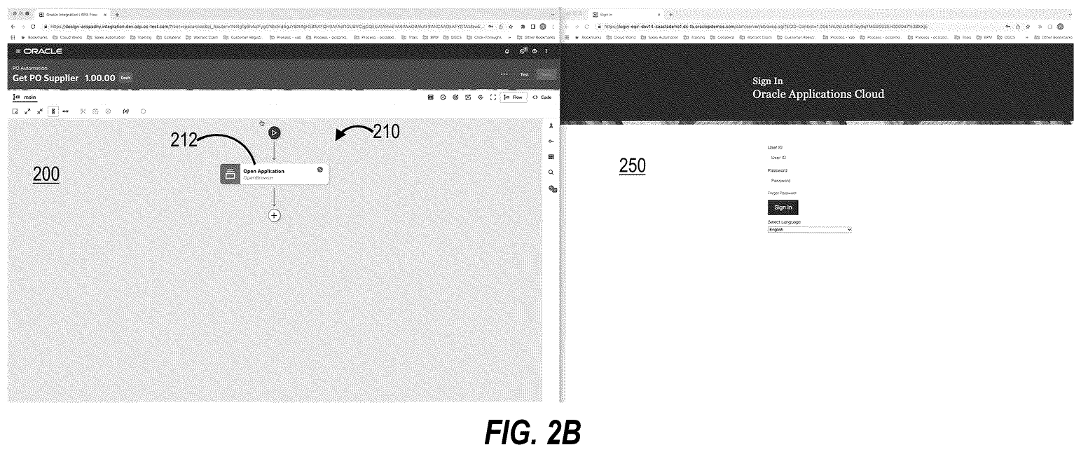

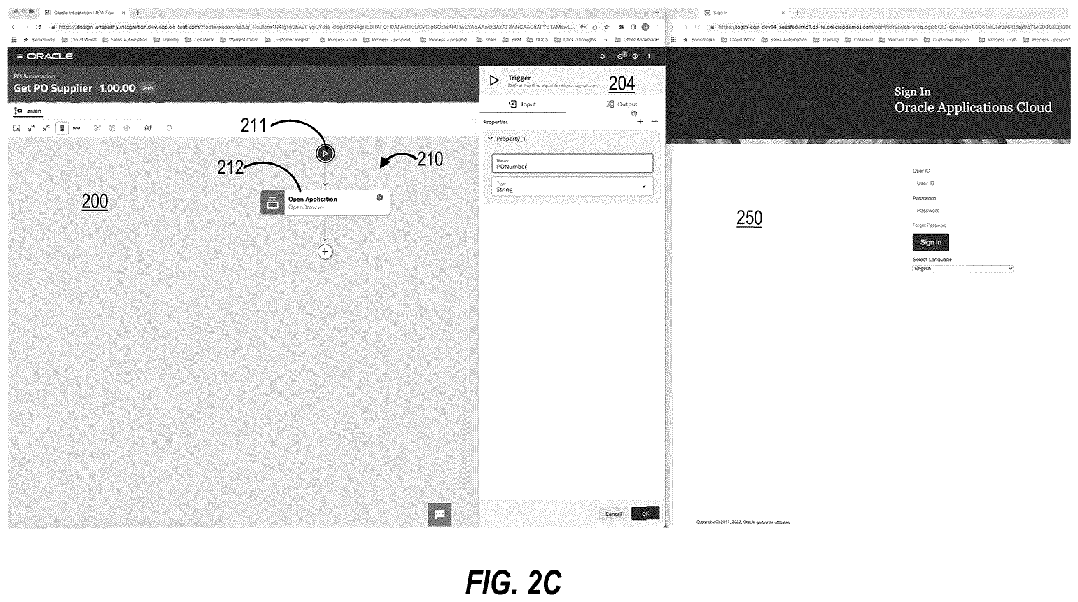

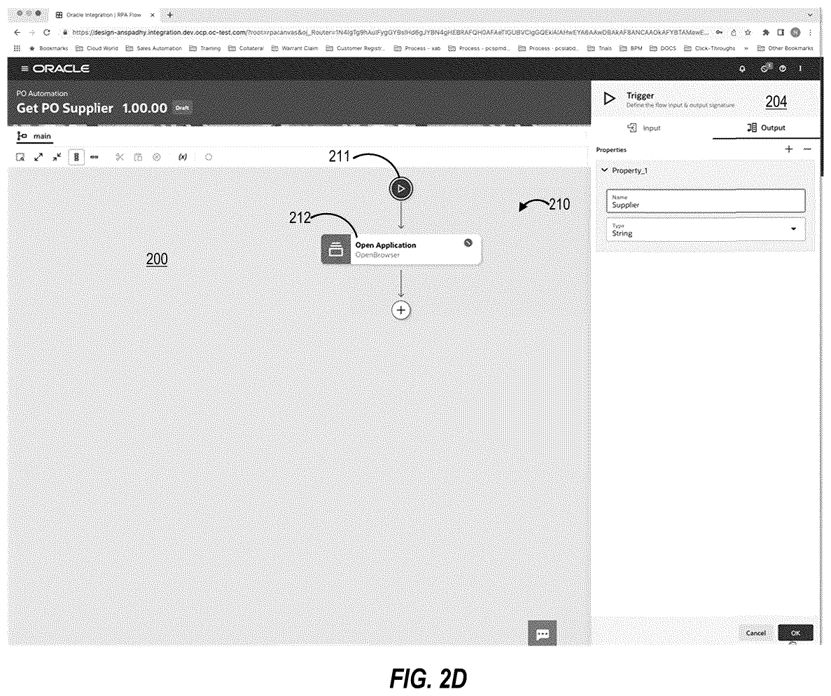

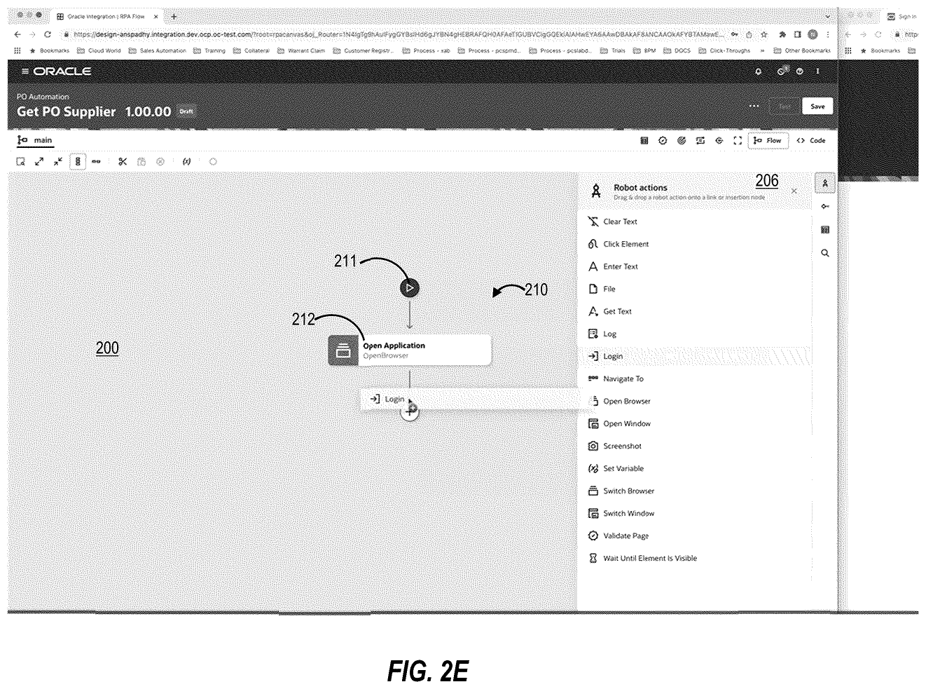

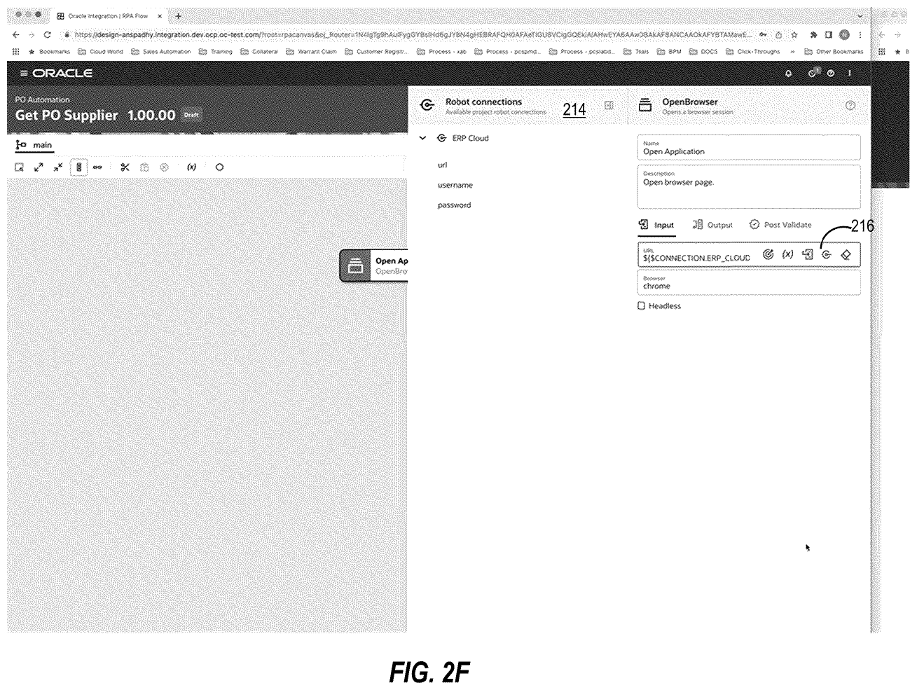

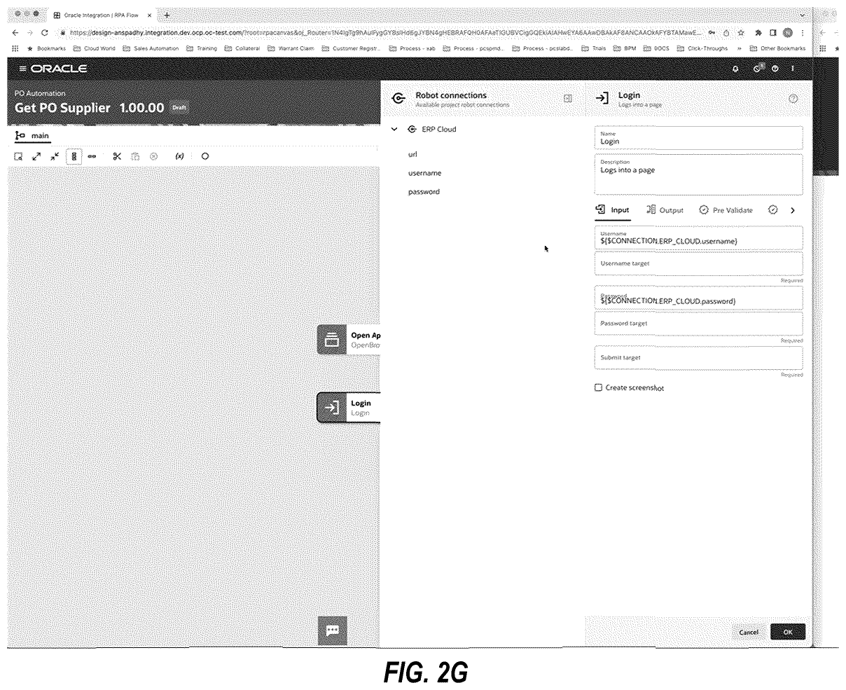

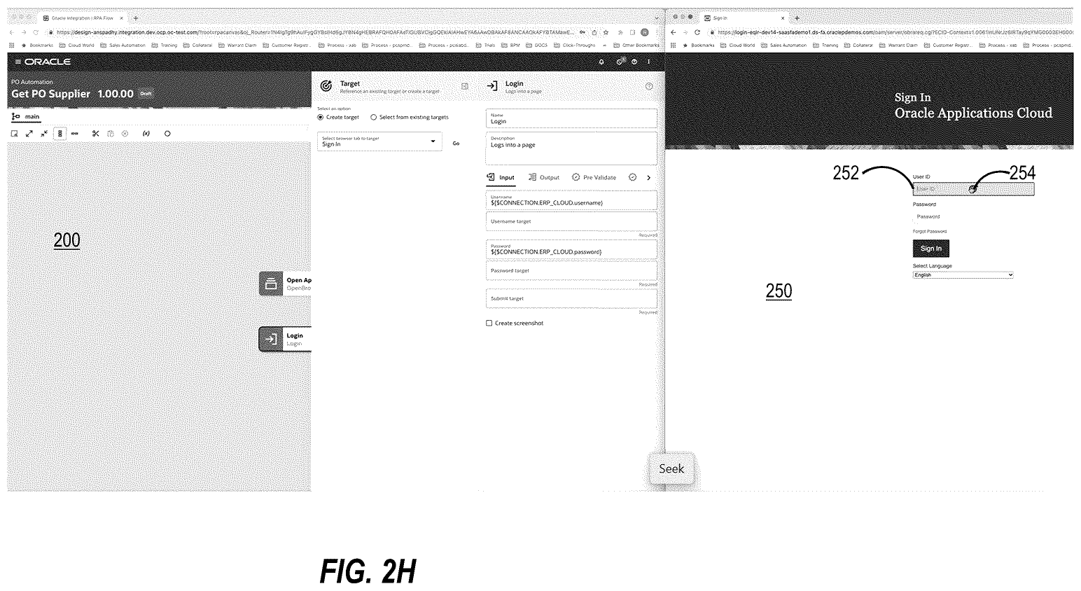

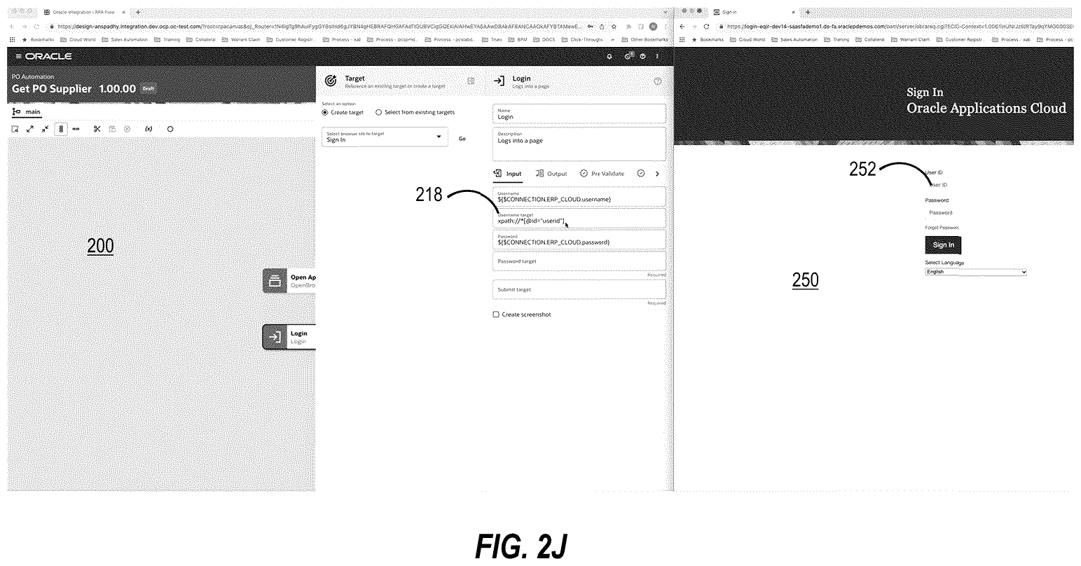

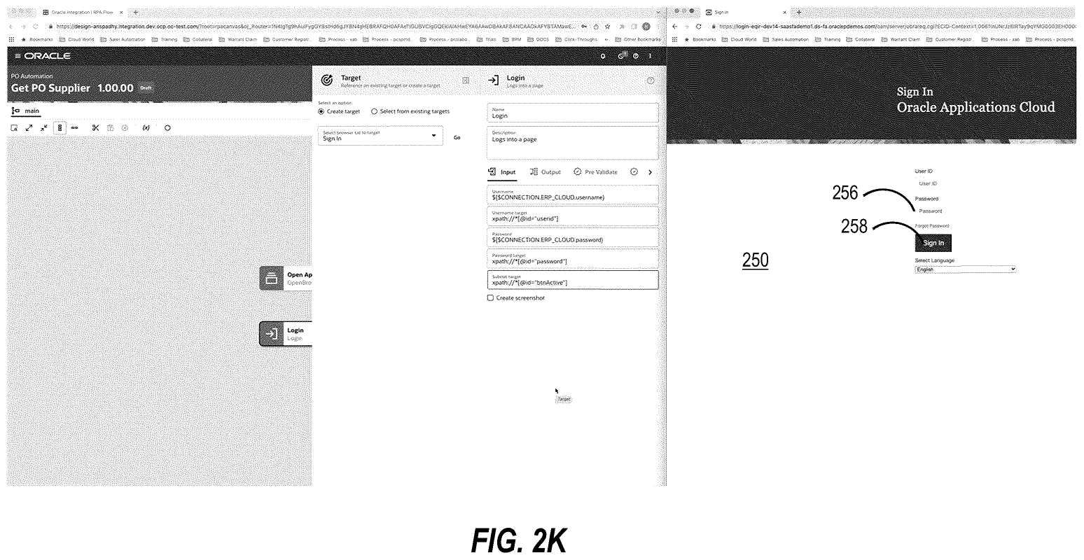

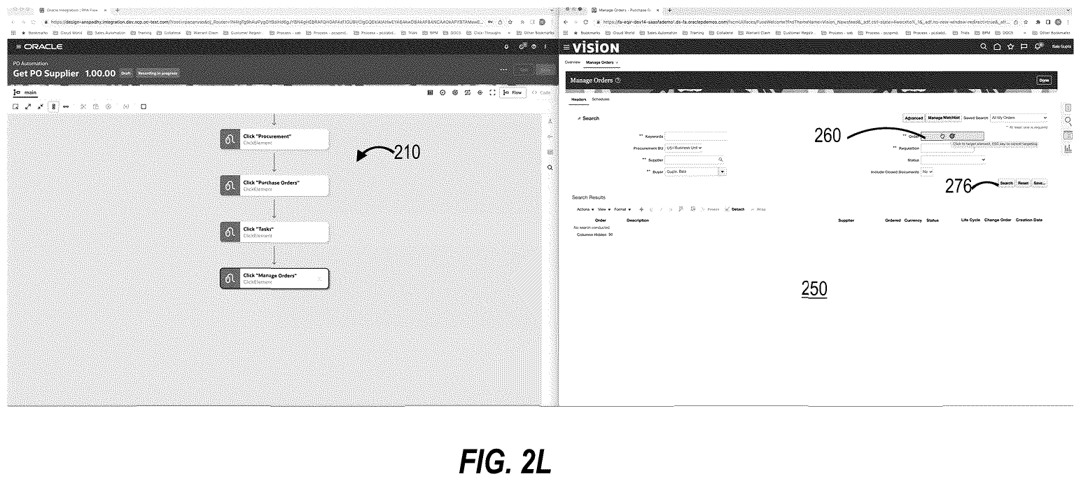

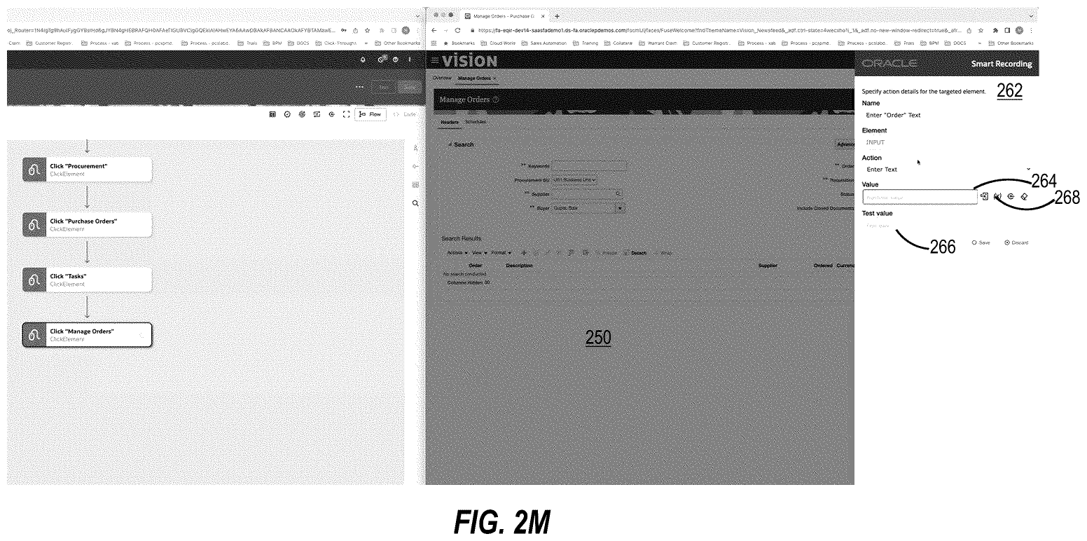

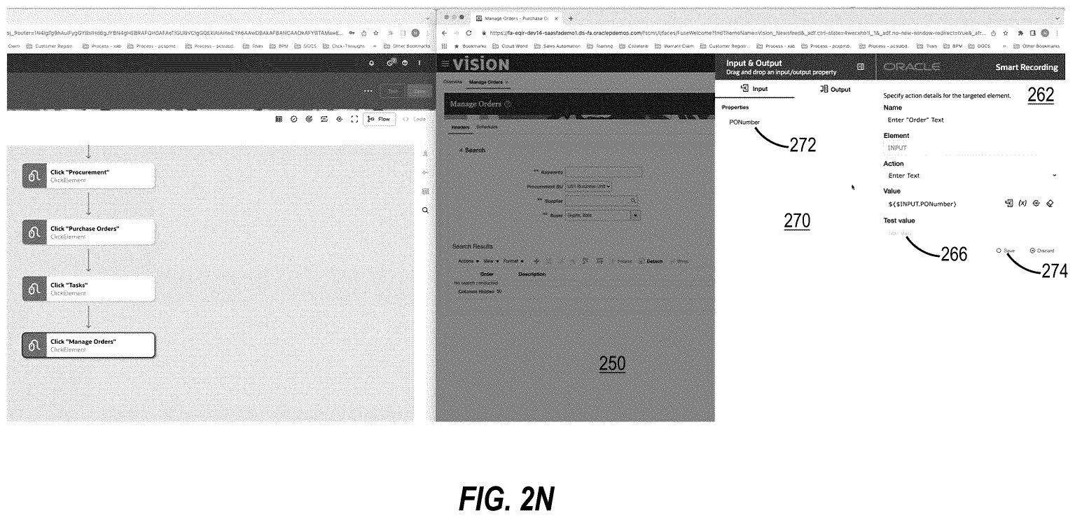

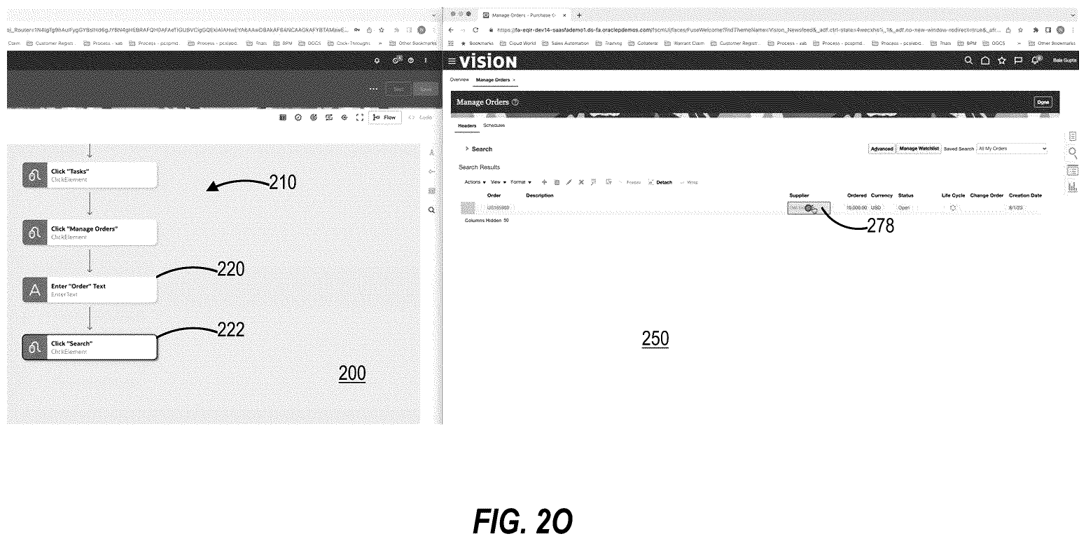

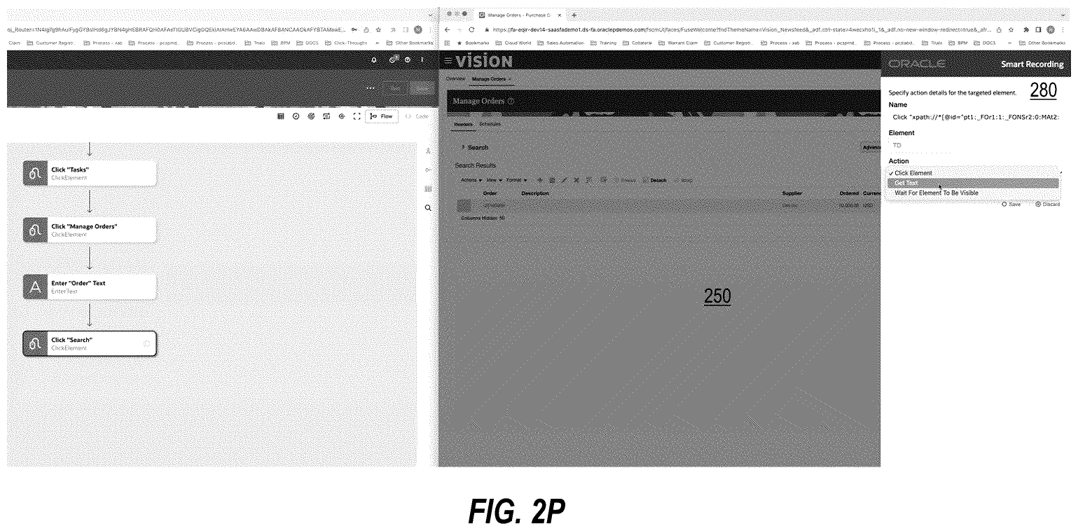

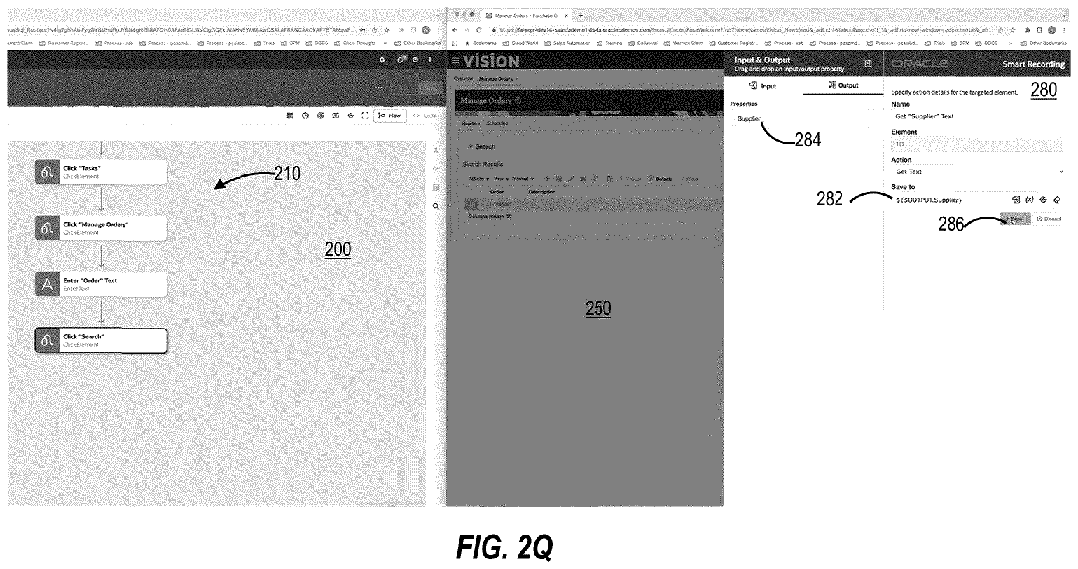

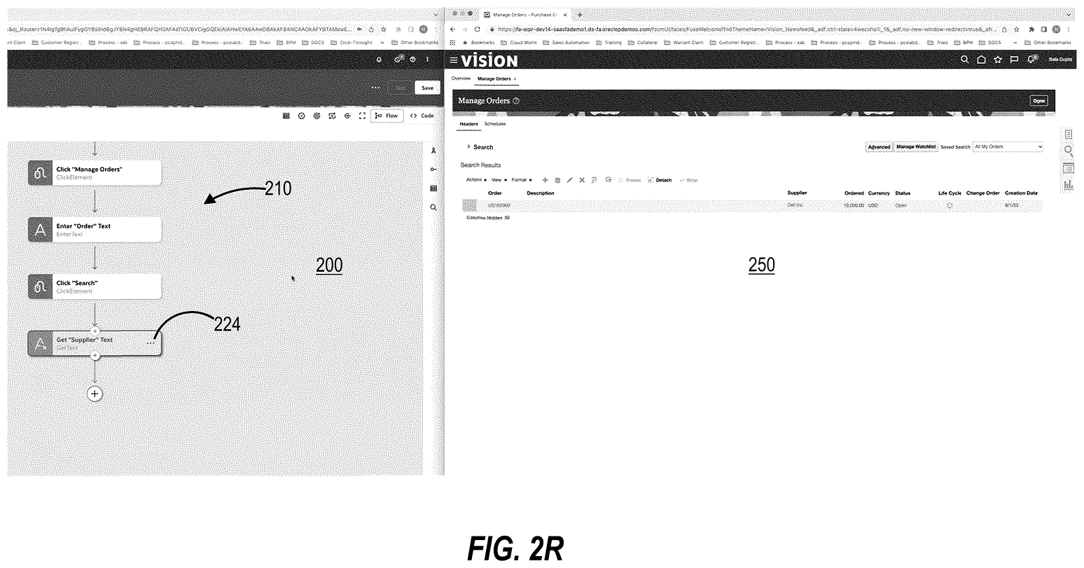

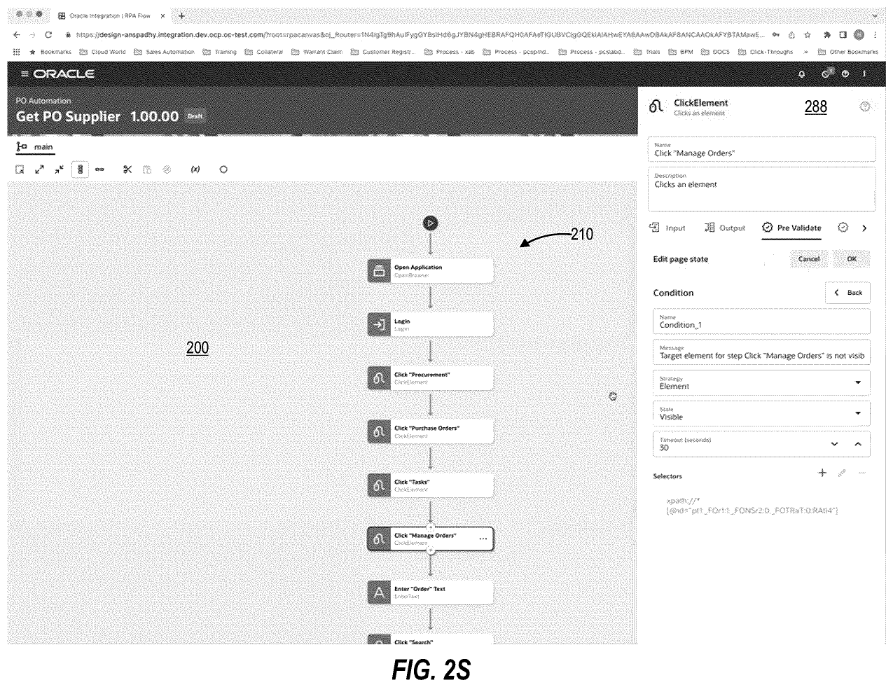

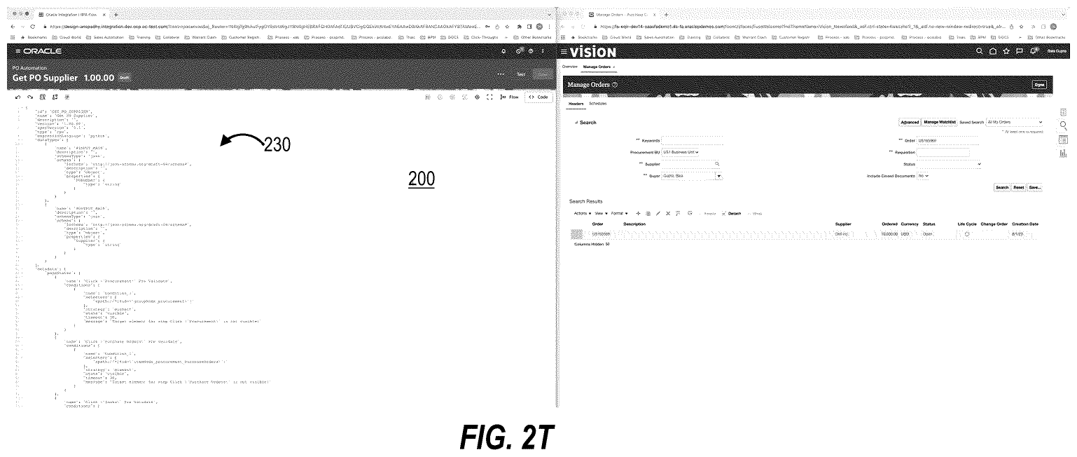

FIGS. 2A-2S are screenshots of a screen of a computing device, depicting an example process for recording user actions and creating and modifying a workflow, in an embodiment. Multiple screenshots in FIGS. 2A-2S (though not all) have two browser windows open: a right window for presenting a webpage with which a user's actions will be recorded (“recorded window 250”), and a left window for displaying results of the recording in a workflow (“workflow window 200”). Recorded window 250 presents output from recordable application 120, while workflow window 200 presents output from workflow application 110.

Workflow window 200 in FIG. 2A allows a user to create a new workflow, referred to as a Robot Flow. Workflow window 200 may be considered a “low code environment,” although no code is presented. However, a workflow presented in workflow window 200 is translated into executable (or interpretable) code that a robot executes with respect to one or more webpages of a website. Workflow window 200 has a pane 202 on the right side of workflow window 200 that allows the user to specify a name for the Robot Flow (“Get PO Supplier”), from which an identifier is automatically created (“GET_PO_SUPPLIER”). The user may enter other attributes for the new Robot Flow, such as a description and keywords.

FIG. 2B depicts contents of workflow window 200 after the new Robot Flow is created, referred to as workflow 210. Each new Robot Flow (or workflow) may have at least an Open Browser node 212, which corresponds to an Open Browser action. In this example, Open Browser node 212 is named Open Application. Also, workflow window 200 indicates the name of the new Robot Flow, “Get PO Supplier [version] 1.00.00,” which was provided by the user through user input.

FIG. 2C depicts contents of workflow window 200 after the user selects the triangle “play” button 211 adjacent to (above) Open Browser node 212 in workflow 210. This causes pane 204 in the right side of the workflow window to be displayed, which pane allows the user to define the input to, and output from, this new Robot Flow. Thus, another application may call this workflow 210 and pass an input value and expect a certain type of output value to be returned from calling workflow 210. In this figure, the user enters a name of an input variable (“PONumber”). (Some workflows may have multiple input variables.) The type of variable “String” may be a default value. Other data types may be selectable by the user, such as Number and Date. Some workflows might not have any input variables, any output variables, or both.

FIG. 2D depicts pane 204 of FIG. 2C after the user enters a name for an output variable, which is “Supplier.” After specifying an output variable, the user may select the save button in the bottom right of pane 204, which causes these input and output definitions to be saved to workflow 210.

FIG. 2E depicts a list of actions that a robot may perform. The list of actions is displayed in pane 206 on the right side of workflow window 200, where workflow 210 is being defined. A user may select actions to include in workflow 210 or may perform actions in recorded window 250, which actions are recorded and automatically added to workflow 210 in workflow window 200. In this example, the user selects a login action, from the list of actions, to add to workflow 210. In this way, the user does not have to go through the login page (presented in recorded window 250 of FIGS. 2A-2C) and have the user's actions recorded in order to create a login node for workflow 210.

The list of actions includes Clear Text, Click Element (e.g., a button or checkbox), Enter Text, File, Get Text, Log, Login, Navigate To, Open Browser, Open Window, Screenshot, Set Variable, Switch Browser, Switch Window, Validate Page, Wait Until Element is Visible. Some of these actions may be part of another action. For example, the Get Text action may include a Wait Until Element is Visible action and a Validate Page action. Thus, these “sub-actions” may be associated with a node in a visible/displayed workflow, but the sub-actions are not visible until the node is selected (e.g., a single mouse click) or “opened up” (through double clicking or other user input).

Thus, some actions may represent multiple sub-actions or regular actions. Some actions may be intent based, such as the Login action, which may comprise an Open Browser action, an Open Window action, two Enter Text actions (e.g., one for user name and one for password), and a Click Element action (e.g., clicking a Sign In button).

FIG. 2F depicts attributes whose values may be set by a user for an Open Browser action. Different actions may have different attributes. For this Open Browser action, the attributes include Name, Description, an Input variable, and an Output variable. An input variable for the Open Browser is a URL and a browser specification. In this example, a value for the input variable “url” comes from an ERP cloud. In this example, there are three variable names listed under an ERP cloud menu 214: url, username, and password. ERP cloud menu 214 may be displayed in response to user selection of the second-to-last icon in URL field 216 (there are 5 icons in that field).

Variables in ERP cloud menu 214 are pre-defined. The values of one or more of these variables (such as username and password) may be hidden, or not visible, to users of workflow application 110. This visibility attribute of values of some variables in ERP cloud menu 214 may be established for security purposes. The values of such “secret” variables or parameters of ERP cloud menu 214 are passed in (by the infrastructure of recorder 122) to the robot during production or runtime, but the values are defined as part of the configuration of recorder 122 and not defined as part of the interface of recorder 122. This allows an administrator to prevent a user who is managing the recording process from viewing the secret variable/parameter values.

FIG. 2G depicts attributes whose values may be set by a user for a Login action, which comes after an Open Browser action. For this Login action, the attributes also include Name, Description, an Input variable, and an Output variable. As in FIG. 2F, values for the username and password come from the ERP cloud by the user selecting those names in ERP cloud menu 214. In the depicted example, the Username “${$CONNECTION.ERP_CLOUD.username}” is displayed in the Username text field in the Login pane in response to a user selecting “username” in the Robot Connections pane of FIG. 2G. Similarly, the Password “${$CONNECTION.ERP_CLOUD. password}” is displayed in the Password text field in the Login pane in response to a user selecting “password” in the Robot Connections pane of FIG. 2G.

FIG. 2H depicts a way for a user to inform a robot where certain data is to be entered into a webpage. In this example, the context is a user login. In this example, the user selects a user ID text field 252 in recorded window 250. In response, user ID text field 252 is highlighted green and a target icon 254 (two or three black circles that increase in size from smallest to largest) is displayed. The user can then select target icon 254, indicating that the selected text field is a target to enter the user's username. The location of the select UI element (in this case, a text field) is an XPath that informs the robot where to enter the username, which comes from the ERP cloud. Generally, UI elements in a website that is being recorded may be highlighted as a user's cursor (controlled by a cursor control device (or mouse)) hovers over those UI elements.

FIG. 2J depicts a version of FIG. 2H, but after the user selects user ID text field 252 in recorded window 250 (which includes the recorded webpage). The XPath of user ID text field 252 in the webpage in recorded window 250 is populated in a username target text field 218 in the login pane of workflow window 200.

FIG. 2K depicts a version of FIG. 2J, but after the user selects a password text field 256 and Sign In button 258 in recorded window 250, wherein the login pane in workflow window 200 includes the XPath of password text field 256 (where the robot, when executed, will input the password from the ERP cloud) and the XPath of Sign In button 258 (which the robot, when executed, will select in the proper sequence in order to ensure that the username and password are filled in and submitted at the time button 258 is selected).

FIG. 2L depicts a point later in development of the Robot Flow with multiple Click Element actions that have been added to workflow 210. The last node in workflow 210 is named “Click ‘Manage Orders’” and the webpage that is displayed in response to a user selecting a Manage Orders button in a previous webpage is a Manage Orders webpage, which is presented in recorded window 250 of FIG. 2L. The user selects an Order text field 260, which is highlighted and has a target icon. In an embodiment, recorded window 250 does not provide an output option in response to detecting a Click Element action, since such actions are to click or select an element, not save data to a certain output.

FIG. 2M depicts a pane 262 that is opened on the right side of recorded window 250, which pane is displayed in response to the user selecting the target icon or Order text field 260 in recorded window 250 of FIG. 2L. The target element here is, therefore, Order text field 260. As pane 262 indicates, the target element is an “INPUT” element and the action is “Enter Text.” The user can then specify a value, which may come from one of multiple sources: (1) the user entering the value directly; (2) from an input variable (icon 268 listed within a runtime value text field 264); (3) a result of a function call; and (4) a value from an ERP cloud. If the user specifies a value directly, then the value is “hard-coded” and whenever a robot that executes this part of workflow 210, the robot will enter that value in Order text field 260 of the Manage Orders webpage. This is not desirable behavior. In prior approaches, a recorder would simply record the value that the user enters into the text field and that value would be recorded in a recording. The user would then have to traverse output of a recording for the location where the user entered the value and change the value to something else, which requires the user to (a) remember this stage of the recording and (b) know how to read and analyze output of recordings.

In an embodiment, recorder 122 provides the ability for a user to specify both a runtime (or production) value and a test value. A runtime value is eventually used when a robot executes a node, in a workflow, that includes the runtime value. A test value is used only during the recording process in order to advance to the next stage (or webpage) in the recording process. Pane 262 is an example of a user interface that includes both runtime value text field 264 and a test value text field 266.

FIG. 2N depicts an input/output pane 270 in recorded window 250, which pane is to the left of pane 262. Input/output pane 270 is displayed in response to the user selecting icon 268 in pane 262. In this example, the user selected PONumber variable 272 listed in input/output pane 270, which variable was defined previously in the workflow development process. In response to the user selecting PONumber variable 272, a reference to that variable is included in the Value text field of pane 270.

Even with selecting PONumber variable 272, the user wants to keep recording his/her actions as he performs actions relevant to the website. Thus, the user can also specify a value in test value text field 266 of pane 262. Then, after selecting Save button 274 in pane 262, pane 262 disappears and the user-specified test value will populate Order text field 260 in the webpage presented in recorded window 250. The user can then select Search button 276 in the webpage presented in recorded window 250 of FIG. 2L, which causes an updated webpage to be presented with information about the order corresponding to the specified test value.

FIG. 2O depicts an updated webpage, along with two new nodes in workflow 210 in workflow window 200: an Enter “Order” Text node 220, and a Click “Search” node 222. FIG. 2O also indicates an updated webpage in recorded window 250 that depicts information from a row of an orders table, the row being identified by the test value entered previously, the test value being an order number. The updated webpage of recorded window 250 also indicates that the user is about to select “Supplier” text field 278.

FIG. 2P depicts an action recording pane 280 (in recorded window 250) that is displayed in response to the user selecting “Supplier” text field 278 depicted in FIG. 2O. Action pane 280 includes a default name, which is the XPath of the Supplier text field 278 in the corresponding webpage. The user may update the name to be more descriptive for the user or other users. Because the selected area in FIG. 2O contains both text and a link, action recording pane 280 presents three action options: a Click Element action, a Get Text action, and a Wait For Element To Be Visible action. In this example, because the user wants a robot that is executing the corresponding workflow to retrieve a name of the supplier, the user selects the Get Text action.

FIG. 2Q depicts action recording pane 280 after the user has given the action a new name (i.e., “Get ‘Supplier’ Text”), the user has selected the first icon in “Save to” field 282, and the user has selected an output variable 284 named “Supplier,” which was defined previously. A reference to output variable 284 is included in “Save to” field 282. After “Save” button 286 in action recording pane 280 is selected, a Get “Supplier” Text node 224 is added to workflow 210 in workflow window 200, as depicted in FIG. 2R.

Once recording is complete, a robot can execute workflow 210 without further changes to workflow 210. However, the user can select any of the nodes in workflow 210 and make one or more changes, such as adding or deleting nodes, modifying attributes of nodes, or adding, modifying, or removing pre-validations, which are described herein.

### Pre-Validations

In an embodiment, recorder 122 automatically generates pre-validations during a recording. A pre-validation is run to check whether certain elements on a webpage exist (such as a search button or a certain text field) or whether other conditions are met before allowing the robot to continue. If a pre-validation fails, then a message corresponding to the pre-validation is displayed, such as while the robot is running. Alternatively, the message is recorded in a playback log. The message allows a user to determine why execution of a workflow by a robot failed.

FIG. 2S depicts a Click Element action pane 288 in workflow window 200. In this example, a pre-validation is automatically created when a node in workflow 210 is created based on recording user actions in recorded webpage 250. The depicted pre-validation is that the element in question is visible or rendered prior to the robot selecting the element in the corresponding webpage. While executing the corresponding node in workflow 210, if the robot attempts to click the element (the Manage Orders UI element in this example) before the element is visible, then the robot will fail. In this example, an error message is automatically generated for the pre-validation and the message will be generated in output generated by the robot while executing workflow 210. The error message is generated and included in the pre-validation before the condition of the pre-validation is evaluated. The error message may be based on a template message where the name of the node is included in the template message in order to generate the error message. The error message may be modified by a user. Such user-friendly error messages, if presented during a test run or in production, make activity logs much easier to view and interpret and, therefore can help reduce the time to identify and resolve errors.

Also in this example, there is a timeout of 30 seconds (which may be a default value that a user is able to modify prior to the pre-validation being automatically evaluated in production or in a test run), meaning that if the UI element is not visible for 30 seconds after the corresponding webpage is selected, then the error message will be recorded. However, until 30 seconds passes, the robot will keep trying to click the UI element so that the robot is not idle for 30 seconds.

### Highlighting

In an embodiment, recorder 122 causes a portion of a recorded webpage to be highlighted based on a location of a cursor on the recorded webpage. As a user provides input to move the cursor, a different portion of the recorded webpage may be highlighted and the previous highlighted portion is no longer highlighted. Example input may be moving a cursor control device, such as a “mouse.”

Recorder 122 determines which portion of a webpage to highlight based on one or more criteria, such as where the cursor is in the structure of the webpage. However, a webpage may comprise many overlapping portions or elements. For example, a webpage may have a header portion, a main portion, and a footer portion, where the main portion may include a table, and the table includes rows and columns, and a cell corresponding to the intersection of a row and column contains multiple values. Therefore, if a cursor is over one of the multiple values, it might not be clear which webpage element to highlight: the whole webpage, the main, portion, the table, the cell, or the value. In an embodiment, recorder 122 identifies an element in the recorded webpage that is more specific than any other element in which the cursor is located. Each element has a pathname in a markup language of the webpage, an example of the markup language being HTML. In HTML, a pathname comprises a sequence of one or more tags. Thus, in the example above, the value is highlighted, but not the cell, the table, or the main portion of the webpage as a whole. Recorder 122 may identify a plurality of elements in which a cursor is located, and then determine which element of the plurality of elements is the furthest element from the root element. In other words, recorder 122 selects, from among the plurality of elements, the element that has the most tags. In the example above, the element representing the webpage is the root element, the main portion is a child element of that root element, the table is a child element of the main portion, the cell is a child element of the table, and each value is a child element of the cell. Thus, in this embodiment, recorder 122 selects the element that is farthest from the root element to highlight.

### Full Code Environment

FIG. 2T depicts recording code 230 that defines a workflow. This code may be displayed in response to selecting a Code button in a previous version of workflow window 200. This view of recording code 230 upon which workflow 210 is based may be considered a “full code” environment. A user may modify this code, which may be eventually executed by a robot.

### Get Text

In an embodiment, while recording, when a user clicks on text (e.g., and the text is not associated with a link and, therefore, recorder 122 determines that the action is a Get Text action) and, based on this determination, recorder 122 automatically selects a “Save To” option to display in a control pane (generated by recorder 122; e.g., displayed on the right side of recorded window 250), which allows the user to specify a location where to save the selected text. The text may be saved to output (i.e., of the entity that will call the robot to execute the corresponding workflow; e.g., a database table, a file, etc.), to an internal variable that is used later in the workflow, or to a third-party data source.

### Multiple Options Per User Action

In an embodiment, while recording, when a user clicks on a data item that is associated with multiple possible actions (e.g., the data item may comprise text and a link to another page), recorder 122 presents a prompt asking the user which of the possible actions the user would like to record. For example, recorder 122 asks (e.g., through a prompt or control window) whether the user wants to obtain the text or click the link element.

### Global Definition of References

In an embodiment, recorder 122 includes a reference for an action (e.g., click Search button). The reference is recorded in a node of a workflow, such as workflow 210. If the action is performed multiple times by a user during a recording, then the reference is used each time. Each reference points to a global definition, where the global definition defines where the search button is in the corresponding webpage. Thus, if a website admin changes the location of the search button in the webpage, then the actions that involve that search action will be invalid until the global definition is updated, which requires user input to fix the problem so that the robot does not fail when executing the workflow. However, only one update to the search button location is needed since all references point to the same global definition. This reduces the amount of user effort required to update an existing workflow when interactive/GUI elements on a webpage change.

### Playing Back a Recording

In an embodiment, given a recording, a user provides input that causes recorder 122 (or another component not depicted) to run the recording. (Executing or running a recording is also referred to as a “playback.”) As recorder 122 runs the recording, the webpage on the right may be updated at each step. This allows a user that created the recording (or a user that is viewing the recording for the first time) to view actions/gestures that the recording user preformed during the recording. The playback of a recording may be at the same pace or rate as the original user gestures were recorded. For example, if there was a pause of ten seconds between user gestures, then the playback will have a ten second pause between those two actions that are automated. Alternatively, recorder 122 performs the playback at a constant rate, such as four seconds between steps or actions. During a playback, a mouse may be visible as well as fields and/or buttons that are highlighted when a corresponding action is performed automatically by recorder 122.

In an embodiment, given a recording, a user can run the recording from any particular action or step, not just from the beginning of the recording. For example, the user can select an intermediate node in a workflow that was created during a recording of user gestures with respect to a webpage. A robot (executing the workflow) can then present, in the recorded window or webpage that is being recorded, the webpage that corresponds to the selected node. The robot proceeds to playback the recording from that selected node to the last node in the workflow. This is an example of a partial playback of the recording.

Alternatively, depending on user input that triggers the playback, the robot executes the workflow from the beginning until the selected node. This is another example of a partial playback of a recording.

Alternatively, depending on the user input that triggers the playback (and/or based on the current node that is being presented in the recorded webpage), the robot executes the workflow from that current node and then performs the one or more intermediate steps of one or more intermediate nodes until a selected node is reached and the recorded website is updated to reflect that point in the workflow. This is another example of a partial playback of a recording. If the current page in the recorded website is beyond a node in the workflow where the user desires to be (e.g., the user selects node 4 and the current page corresponds to node 7), then the robot may playback the workflow from the beginning and proceed until the webpage corresponding to node 4 is reached.

In situations where a user makes an error during the recording process, such as not entering a PO number in the Order text field (which would result a table of many rows), the low code environment in the workflow window (e.g., workflow window 200) allows the user to go back to the webpage where the user was supposed to enter a PO number in the Order text field and add an action in the workflow, where the action is Enter Text. Thus, a user can fix a workflow without having to work entirely in the low code environment. The user can go back and forth between the low code environment (of workflow window 200) and the no code environment (of recorded window 250).

During a playback of a recording, a robot can run the parameterized variable or the test value. In an embodiment, the system asks the user which option the user desires and the user can provide input that selects one of the options. One of the options may be default selected.

### Test Runs

In an embodiment, once a workflow is generated, the workflow can be tested by running it one or more times. This will allow the user to view how the workflow performed in a test run and if any further changes are necessary.

In a related embodiment, during a test run of a workflow, a user may provide input that causes the test run to cease, i.e., before all the nodes of the workflow are executed. For example, a user interface includes a pause button that is displayed, at least when the test run is executing. The user interface (e.g., in workflow window 200) may also include a play button that is displayed, at least when the test run is paused. To resume a paused test run, the user may select (via the user interface) the play button.

In a related embodiment, prior to a test run, a user may provide input that indicates a portion of a workflow to run rather than executing all of the workflow. For example, the user selects the fifth node in a workflow (e.g., causing a UI element (e.g., a popup window) to be displayed in workflow window 200) and provides input (e.g., in the UI element) that indicates the intention to run just the first node through the fifth node, and not all the nodes in the workflow.

As another example, the user provides input that indicates an intention to initiate a test run of a workflow and a UI element is displayed and the user provides, through the UI element, input that indicates the fourth node in the workflow at which the test run is to cease. As another example, the user provides input that selects a node in the workflow that is not the first node in the workflow, causing a test run to proceed from the selected node.

As another example, a user provides input that initiates a test run and the test run software program determines which node, in a workflow, from which to initiate the test run and the determined node is not the first node in the workflow. For example, the test run software program identifies a particular node that corresponds to the currently-displayed webpage in the recorded workflow. The test run software program presumes that the user intends to initiate the test run from that particular node (or the “starting node”). The user may provide input that overrides that presumption or confirms that presumption. The user may also provide input that specifies which node at which the test run is to end (or “ending node”). After the test run software program identifies the starting node (which may be an intermediate node in the workflow, which node is neither the first node nor the last node in the workflow), the test run begins at the starting node and proceeds to the ending node, which may be identified after the test run begins at the starting node.

In an embodiment, selecting a node in a workflow causes a UI element to be presented, such as a popup window. The UI element lists one or more actions to initiate, such as “initiate a test run from the beginning node, ending at this node,” “initiate a test run from this node, ending at the last node,” and “initiate a test run from this node, ending at another user-specified node.”

### Test Values

In an embodiment, during a recording, recorder 122 automatically recognizes an input value that a user puts into a text field and automatically assumes that the input value is a test value. Thus, recorder 122 fills in a Test value field with the input value and leaves the Value field blank, allowing the user to specify an input variable, a function, or an ERP cloud variable.

In a related embodiment, during a test run of a workflow, a test run software program asks the user whether the test value or the parameterized value should be used during the test run. The test run software program may detect a test value of a node while the test run software program is executing the node during a test run and, at the time of detection, present a prompt to the user, asking whether the test value should be used during the test run. Alternatively, the test run software program may detect all test values of all nodes in a workflow prior to initiating a test run of the workflow and cause one or more prompts to be presented in a user interface, allowing a user to select a test value option or a parameterized value option for each detected test value. If there are multiple detections of test values in a single workflow, a single prompt may be presented that includes all the test values or multiple prompts may be presented, each corresponding to a different detected test value.

### Computer-Related Improvements

Embodiments improve computer-related technology pertaining to digital recorders of user gestures (or actions) relative to a software application. Embodiments include the ability to view and edit user actions during the recording process. In this way, a user is not required to view a (oftentimes complicated) script of a recording and manually modify the script. Also, embodiments allow a recorder to use input data, to the recording, that is different from the input data that will be used during later execution of the recording. Because all necessary information can be specified during the recording, no after recording modifications are required.

Additionally, embodiments allow the user to specify one of many possible output actions based on a single gesture or user action. Again, this allows a user to skip making after recording modifications to a complicated script.

Furthermore, embodiments predict the output action based on the element with which the user has interacted. Based on the user gesture, a recorder fills out much of the action information for the user automatically. Thus, the recorder can generate different output for the same user gestures, depending on user input during the recording regarding what that output will be. No analysis or modification after a recording is required because the recorder interacts with the application using the output during the recording process. This recorder also allows the user to interact with a web page but has some of the user gestures filtered out of the output of the recording. Current recorders record every interaction with a web page, whereas embodiments allow the user to make gestures that are not recorded but still allow the user to progress through the web page. This makes it possible to modify the web page and get past situations where a recorder cannot record user input, such as when a native control is used on a web page.

Additional computer-related improvements due to embodiments include that some embodiments are web-based within the context of the solution being built. Also, embodiments seamlessly combining the convenience of a recorder with the control of a low code environment, and, while recording, the user is engaged in the code composition process, allowing the user to define the activity as the user would want the activity to run in production, rather than a recorder blindly copying whatever input the user provided. After recording, users are not required to go back into the code to make the workflow work.

Additional computer-related improvements due to embodiments include the ability to parameterize, the ability to dynamically change from where to perform the recording, the ability to edit the recording once the recording is complete, and the ability to run the code, and tie the code back to the recording experience. Another improvement is injecting a control window into the webpage that is being recorded. For the recording of inputting values, one of the fields in the control window may be for production at runtime while another of the fields in the control window may be for recording for future tests.

### Hardware Over View

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

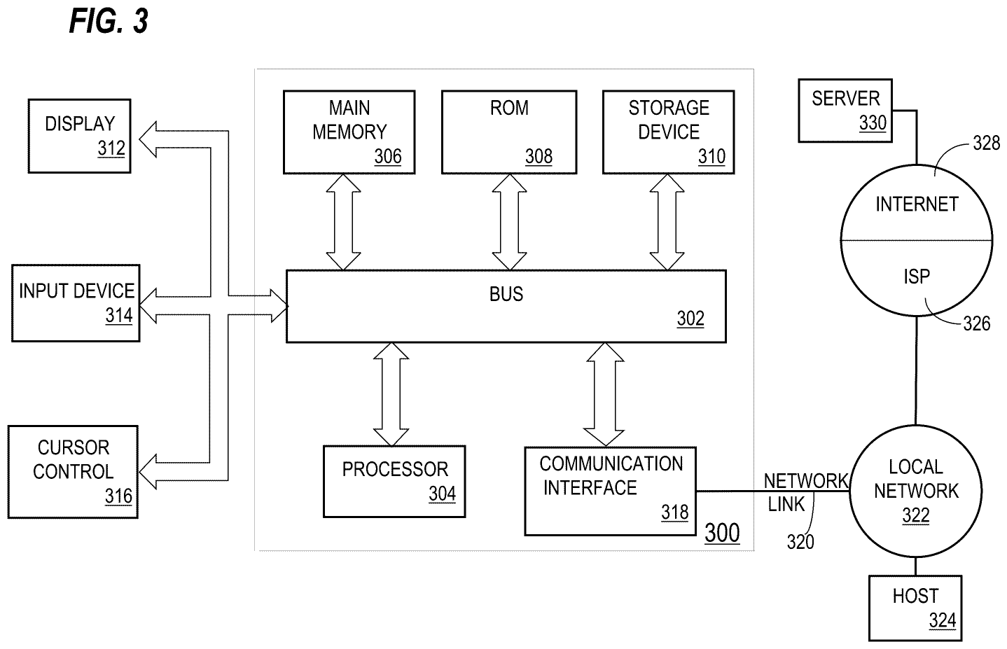

For example, FIG. 3 is a block diagram that illustrates a computer system 300 upon which an embodiment of the invention may be implemented. Computer system 300 includes a bus 302 or other communication mechanism for communicating information, and a hardware processor 304 coupled with bus 302 for processing information. Hardware processor 304 may be, for example, a general purpose microprocessor.

Computer system 300 also includes a main memory 306, such as a random access memory (RAM) or other dynamic storage device, coupled to bus 302 for storing information and instructions to be executed by processor 304. Main memory 306 also may be used for storing temporary variables or other intermediate information during execution of instructions to be executed by processor 304. Such instructions, when stored in non-transitory storage media accessible to processor 304, render computer system 300 into a special-purpose machine that is customized to perform the operations specified in the instructions.

Computer system 300 further includes a read only memory (ROM) 308 or other static storage device coupled to bus 302 for storing static information and instructions for processor 304. A storage device 310, such as a magnetic disk, optical disk, or solid-state drive is provided and coupled to bus 302 for storing information and instructions.

Computer system 300 may be coupled via bus 302 to a display 312, such as a cathode ray tube (CRT), for displaying information to a computer user. An input device 314, including alphanumeric and other keys, is coupled to bus 302 for communicating information and command selections to processor 304. Another type of user input device is cursor control 316, such as a mouse, a trackball, or cursor direction keys for communicating direction information and command selections to processor 304 and for controlling cursor movement on display 312. This input device typically has two degrees of freedom in two axes, a first axis (e.g., x) and a second axis (e.g., y), that allows the device to specify positions in a plane.

Computer system 300 may implement the techniques described herein using customized hard-wired logic, one or more ASICs or FPGAs, firmware and/or program logic which in combination with the computer system causes or programs computer system 300 to be a special-purpose machine. According to one embodiment, the techniques herein are performed by computer system 300 in response to processor 304 executing one or more sequences of one or more instructions contained in main memory 306. Such instructions may be read into main memory 306 from another storage medium, such as storage device 310. Execution of the sequences of instructions contained in main memory 306 causes processor 304 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage device 310. Volatile media includes dynamic memory, such as main memory 306. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 302. Transmission media can also take the form of acoustic or light waves, such as those generated during radio-wave and infra-red data communications.

Various forms of media may be involved in carrying one or more sequences of one or more instructions to processor 304 for execution. For example, the instructions may initially be carried on a magnetic disk or solid-state drive of a remote computer. The remote computer can load the instructions into its dynamic memory and send the instructions over a telephone line using a modem. A modem local to computer system 300 can receive the data on the telephone line and use an infra-red transmitter to convert the data to an infra-red signal. An infra-red detector can receive the data carried in the infra-red signal and appropriate circuitry can place the data on bus 302. Bus 302 carries the data to main memory 306, from which processor 304 retrieves and executes the instructions. The instructions received by main memory 306 may optionally be stored on storage device 310 either before or after execution by processor 304.

Computer system 300 also includes a communication interface 318 coupled to bus 302. Communication interface 318 provides a two-way data communication coupling to a network link 320 that is connected to a local network 322. For example, communication interface 318 may be an integrated services digital network (ISDN) card, cable modem, satellite modem, or a modem to provide a data communication connection to a corresponding type of telephone line. As another example, communication interface 318 may be a local area network (LAN) card to provide a data communication connection to a compatible LAN. Wireless links may also be implemented. In any such implementation, communication interface 318 sends and receives electrical, electromagnetic, or optical signals that carry digital data streams representing various types of information.

Network link 320 typically provides data communication through one or more networks to other data devices. For example, network link 320 may provide a connection through local network 322 to a host computer 324 or to data equipment operated by an Internet Service Provider (ISP) 326. ISP 326 in turn provides data communication services through the worldwide packet data communication network now commonly referred to as the “Internet” 328. Local network 322 and Internet 328 both use electrical, electromagnetic, or optical signals that carry digital data streams. The signals through the various networks and the signals on network link 320 and through communication interface 318, which carry the digital data to and from computer system 300, are example forms of transmission media.

Computer system 300 can send messages and receive data, including program code, through the network(s), network link 320 and communication interface 318. In the Internet example, a server 330 might transmit a requested code for an application program through Internet 328, ISP 326, local network 322 and communication interface 318.

The received code may be executed by processor 304 as it is received, and/or stored in storage device 310, or other non-volatile storage for later execution.

### Software Overview

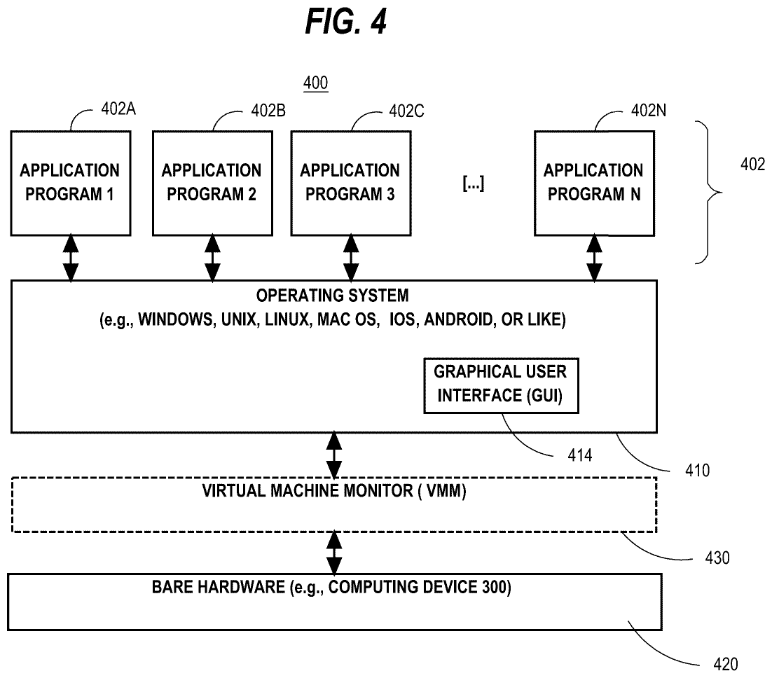

FIG. 4 is a block diagram of a basic software system 400 that may be employed for controlling the operation of computer system 300. Software system 400 and its components, including their connections, relationships, and functions, is meant to be exemplary only, and not meant to limit implementations of the example embodiment(s). Other software systems suitable for implementing the example embodiment(s) may have different components, including components with different connections, relationships, and functions.

Software system 400 is provided for directing the operation of computer system 300. Software system 400, which may be stored in system memory (RAM) 306 and on fixed storage (e.g., hard disk or flash memory) 310, includes a kernel or operating system (OS) 410.

The OS 410 manages low-level aspects of computer operation, including managing execution of processes, memory allocation, file input and output (I/O), and device I/O. One or more application programs, represented as 402A, 402B, 402C . . . 402N, may be “loaded” (e.g., transferred from fixed storage 310 into memory 306) for execution by the system 400. The applications or other software intended for use on computer system 300 may also be stored as a set of downloadable computer-executable instructions, for example, for downloading and installation from an Internet location (e.g., a Web server, an app store, or other online service).

Software system 400 includes a graphical user interface (GUI) 415, for receiving user commands and data in a graphical (e.g., “point-and-click” or “touch gesture”) fashion. These inputs, in turn, may be acted upon by the system 400 in accordance with instructions from operating system 410 and/or application(s) 402. The GUI 415 also serves to display the results of operation from the OS 410 and application(s) 402, whereupon the user may supply additional inputs or terminate the session (e.g., log off).

OS 410 can execute directly on the bare hardware 420 (e.g., processor(s) 304) of computer system 300. Alternatively, a hypervisor or virtual machine monitor (VMM) 430 may be interposed between the bare hardware 420 and the OS 410. In this configuration, VMM 430 acts as a software “cushion” or virtualization layer between the OS 410 and the bare hardware 420 of the computer system 300.

VMM 430 instantiates and runs one or more virtual machine instances (“guest machines”). Each guest machine comprises a “guest” operating system, such as OS 410, and one or more applications, such as application(s) 402, designed to execute on the guest operating system. The VMM 430 presents the guest operating systems with a virtual operating platform and manages the execution of the guest operating systems.

In some instances, the VMM 430 may allow a guest operating system to run as if it is running on the bare hardware 420 of computer system 300 directly. In these instances, the same version of the guest operating system configured to execute on the bare hardware 420 directly may also execute on VMM 430 without modification or reconfiguration. In other words, VMM 430 may provide full hardware and CPU virtualization to a guest operating system in some instances.

In other instances, a guest operating system may be specially designed or configured to execute on VMM 430 for efficiency. In these instances, the guest operating system is “aware” that it executes on a virtual machine monitor. In other words, VMM 430 may provide para-virtualization to a guest operating system in some instances.

A computer system process comprises an allotment of hardware processor time, and an allotment of memory (physical and/or virtual), the allotment of memory being for storing instructions executed by the hardware processor, for storing data generated by the hardware processor executing the instructions, and/or for storing the hardware processor state (e.g. content of registers) between allotments of the hardware processor time when the computer system process is not running. Computer system processes run under the control of an operating system, and may run under the control of other programs being executed on the computer system.

The above-described basic computer hardware and software is presented for purposes of illustrating the basic underlying computer components that may be employed for implementing the example embodiment(s). The example embodiment(s), however, are not necessarily limited to any particular computing environment or computing device configuration. Instead, the example embodiment(s) may be implemented in any type of system architecture or processing environment that one skilled in the art, in light of this disclosure, would understand as capable of supporting the features and functions of the example embodiment(s) presented herein.

### Cloud Computing

The term “cloud computing” is generally used herein to describe a computing model which enables on-demand access to a shared pool of computing resources, such as computer networks, servers, software applications, and services, and which allows for rapid provisioning and release of resources with minimal management effort or service provider interaction.

A cloud computing environment (sometimes referred to as a cloud environment, or a cloud) can be implemented in a variety of different ways to best suit different requirements. For example, in a public cloud environment, the underlying computing infrastructure is owned by an organization that makes its cloud services available to other organizations or to the general public. In contrast, a private cloud environment is generally intended solely for use by, or within, a single organization. A community cloud is intended to be shared by several organizations within a community; while a hybrid cloud comprises two or more types of cloud (e.g., private, community, or public) that are bound together by data and application portability.

Generally, a cloud computing model enables some of those responsibilities which previously may have been provided by an organization's own information technology department, to instead be delivered as service layers within a cloud environment, for use by consumers (either within or external to the organization, according to the cloud's public/private nature). Depending on the particular implementation, the precise definition of components or features provided by or within each cloud service layer can vary, but common examples include: Software as a Service (SaaS), in which consumers use software applications that are running upon a cloud infrastructure, while a SaaS provider manages or controls the underlying cloud infrastructure and applications. Platform as a Service (PaaS), in which consumers can use software programming languages and development tools supported by a PaaS provider to develop, deploy, and otherwise control their own applications, while the PaaS provider manages or controls other aspects of the cloud environment (i.e., everything below the run-time execution environment). Infrastructure as a Service (IaaS), in which consumers can deploy and run arbitrary software applications, and/or provision processing, storage, networks, and other fundamental computing resources, while an IaaS provider manages or controls the underlying physical cloud infrastructure (i.e., everything below the operating system layer). Database as a Service (DBaaS) in which consumers use a database server or Database Management System that is running upon a cloud infrastructure, while a DbaaS provider manages or controls the underlying cloud infrastructure, applications, and servers, including one or more database servers.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A method comprising:
while recording user actions with respect to a website, detecting that a user entered text within a text field of a webpage of the website;
causing an action pane to be presented, wherein the action pane includes a value text field and a test value text field;
in response to the detecting, inserting the text into the test value text field of the action pane;
storing an association between the text, the text field, and the test value text field as part of a workflow;
wherein the method is performed by one or more computing devices.

2. The method of claim 1, wherein the action pane is presented in response to the detecting.

3. The method of claim 1, further comprising:
receiving, through the action pane, user input that selects a reference, to a source of input, to include in the text field during execution of the workflow.

4. The method of claim 3, further comprising:
in response to selection of the reference, updating the value text field, in the action pane, to include the reference.

5. The method of claim 3, wherein the source of input is an input variable of the workflow, a result of a function call, or a cloud source.

6. The method of claim 3, further comprising:
before or during a test run of the workflow, causing a prompt to be presented, wherein the prompt asks a second user whether the text in the test value text field should be used during the test run or whether the reference in the value text field should be used during the test run.

7. The method of claim 1, further comprising:
detecting a plurality of test values in the workflow;
causing one or more prompts to be presented that allows a second user to select, for each test value of the plurality of test values, either said test value or a parameterized option.

8. The method of claim 7, wherein detecting the plurality of test values and causing the one or more prompts to be presented are performed prior to initiating a test run of the workflow.

9. The method of claim 1, further comprising:
receiving, from a computing device a first user, input that specifies a secret parameter to be associated with a particular text field in the website;
wherein a value of the secret parameter is not viewable by the first user and was established by a second user, that is different than the first user, prior to receiving the input;
wherein the secret parameter is a username or a password.

10. The method of claim 1, further comprising:
while recording the user actions with the website, automatically creating one or more pre-validations for one or more graphical nodes in the workflow that is created based on the recording;
while executing the workflow, processing the one or more pre-validations.

11. The method of claim 10, wherein a particular pre-validation of the one or more pre-validations includes a timer, the expiration of which causes a robot that executes the workflow to generate a message that is part of the particular pre-validation.

12. The method of claim 10, wherein a particular pre-validation of the one or more pre-validations is the existence of a user interface element, wherein a robot that executes the workflow, when processing the particular pre-validation, makes multiple attempts to access the UI element when the UI element is not yet visible or rendered.

13. The method of claim 1, further comprising:
while recording the user actions with respect to the website, detecting that the user selects particular text on a second webpage of the website;
causing, to be presented, a second action pane;
receiving, through the second action pane, user input that specifies a location where to save the particular text.

14. The method of claim 13, wherein the location is one of an output source of an entity that executes the workflow, an internal variable that is used later in the workflow, or a third-party data source.

15. One or more non-transitory storage media storing instructions which, when executed by one or more computing devices, cause:
while recording user actions with respect to a website, detecting that a user entered text within a text field of a webpage of the website;
causing an action pane to be presented, wherein the action pane includes a value text field and a test value text field;
in response to the detecting, inserting the text into the test value text field of the action pane;
storing an association between the text, the text field, and the test value text field as part of a workflow.

16. The one or more non-transitory storage media storing instructions of claim 15, wherein the instructions, when executed by the one or more computing devices, further cause:
receiving, through the action pane, user input that selects a reference, to a source of input, to include in the text field during execution of the workflow.

17. The one or more non-transitory storage media storing instructions of claim 15, wherein the instructions, when executed by the one or more computing devices, further cause:
detecting a plurality of test values in the workflow;
causing one or more prompts to be presented that allows a second user to select, for each test value of the plurality of test values, either said test value or a parameterized option.

18. The one or more non-transitory storage media storing instructions of claim 15, wherein the instructions, when executed by the one or more computing devices, further cause:
receiving, from a computing device a first user, input that specifies a secret parameter to be associated with a particular text field in the website;
wherein a value of the secret parameter is not viewable by the first user and was established by a second user, that is different than the first user, prior to receiving the input;
wherein the secret parameter is a username or a password.

19. The one or more non-transitory storage media storing instructions of claim 15, wherein the instructions, when executed by the one or more computing devices, further cause:
while recording the user actions with the website, automatically creating one or more pre-validations for one or more graphical nodes in the workflow that is created based on the recording;
while executing the workflow, processing the one or more pre-validations.

20. The one or more non-transitory storage media storing instructions of claim 15, wherein the instructions, when executed by the one or more computing devices, further cause:
while recording the user actions with respect to the website, detecting that the user selects particular text on a second webpage of the website;
causing, to be presented, a second action pane;
receiving, through the second action pane, user input that specifies a location where to save the particular text.
